(19) United States
(12) Patent Application Publication
(10) Pub. No.: US 2012/0139328 A1
(43) Pub. Date: Jun. 7, 2012

(54) AUTOMOTIVE VEHICLE BRAKE SYSTEM

(75) Inventors: Edward Todd Brown, San Marcos, CA (US); Paul Thomas Geantil, San Diego, CA (US); Richard Lewis Fabini, Cardiff-by-the-Sea, CA (US); Oliver Chin-Liong Kho, Oceanside, CA (US)

(73) Assignee: APTERA MOTORS, INC., Oceanside, CA (US)

(21) Appl. No.: 12/970,176

(22) Filed: Dec. 16, 2010

Related U.S. Application Data
(60) Provisional application No. 61/418,860, filed on Dec. 1, 2010.

(51) Int. Cl. B60T 13/74; B60L 7/18; B60T 8/1755; B60T 8/17; B60T 8/176; B60L 7/10; G06F 19/00

(52) U.S. Cl. 303/3; 701/70; 701/71; 701/48; 701/37

(57) ABSTRACT

An automotive vehicle braking system includes a hydraulic brake system in communication with a regenerative brake system. The regenerative brake system has both a fixed system logic portion and a user-adjustable system logic portion. The fixed system logic of the regenerative brake system is driven by a brake member displacement.

### BACKGROUND AND SUMMARY

The present invention generally pertains to an automotive vehicle brake system and more particularly to a regenerative brake system.

A conventional braking system typically utilizes friction between brake pads and brake rotors for slowing or stopping a vehicle. This action dissipates the vehicle's kinetic energy as heat energy. This friction and resulting dissipation of kinetic energy wastes the vehicle's generated power, reduces fuel efficiency, and leads to higher emissions. It is possible, however, to counter this waste by converting the vehicle's kinetic energy into a form that can later be reused. For example, the vehicle's kinetic energy may be captured and stored for use in a process known as regenerative braking. The kinetic energy collected during regenerative braking, however, does not restore all energy lost during vehicle operation. Moreover, a brake pedal may behave and “feel” differently in regenerative braking systems, as opposed to conventional braking systems. For example, the brake pedal may have a different displacement characteristic than a purely conventional system depending upon execution parameters of the regenerative braking system.

In accordance with the present invention, an automotive vehicle braking system is provided. In another aspect, a hydraulic brake system is in communication with a regenerative brake system. In another aspect, the regenerative brake system has both a fixed system logic and a user-adjustable system logic. In yet another aspect of the present invention, the fixed system logic of the regenerative brake system is driven by a brake member displacement.

The present regenerative braking system and its integration into a total brake system are advantageous over prior regenerative braking systems. For example, the present system and method advantageously integrate both a user-adjustable regeneration from the accelerator pedal and a fixed regeneration from the brake pedal. Notably, both the user-adjustable and fixed regeneration utilize multiple inputs to provide regenerative deceleration smoothly and consistently. Moreover, the present system utilizes regeneration to provide a boosted feel akin to a well-executed conventional braking system. Additional advantages and features of the present invention will be found in the following description and accompanying claims, as well as in the appended drawings.

### BRIEF DESCRIPTION OF THE DRAWINGS

FIG. 1A is a partially fragmented, perspective view of a vehicle having a regenerative braking system;

FIG. 1B is an enlarged view of the regenerative braking system of FIG. 1A;

FIG. 1C is a fragmentary perspective view showing an interior of the vehicle of FIG. 1A;

FIG. 2 is a perspective view of an electronic shift controller for the regenerative braking system of FIG. 1A;

FIG. 3 is a schematic view of a shift control for the electronic shift controller of FIG. 2;

FIG. 4 is a schematic showing connection of the electronic shift controller of FIG. 2;

FIG. 5 is a block diagram showing a control process for the regenerative braking system of FIG. 1A;

FIG. 6 is a block diagram showing a process for obtaining an available deceleration torque at a motor to be inputted into FIG. 5;

FIG. 7 is a block diagram showing a process for obtaining a brake pedal deceleration request to be inputted into FIG. 5;

FIGS. 8A-8C are graphical representations of target ranges for pedal travel, pedal force, and pedal deceleration relationships;

FIG. 9 is a block diagram showing an alternate configuration to FIG. 7;

FIG. 10 is a block diagram showing a process for obtaining an accelerator pedal deceleration torque request to be inputted into FIG. 5;

FIG. 11 is a block diagram showing a regeneration and brake request module for the control process of FIG. 5; and

FIG. 12 is a block diagram showing an alternate configuration to the process of FIG. 11.

Corresponding reference numerals indicate corresponding parts throughout the several views of the drawings.

### DETAILED DESCRIPTION

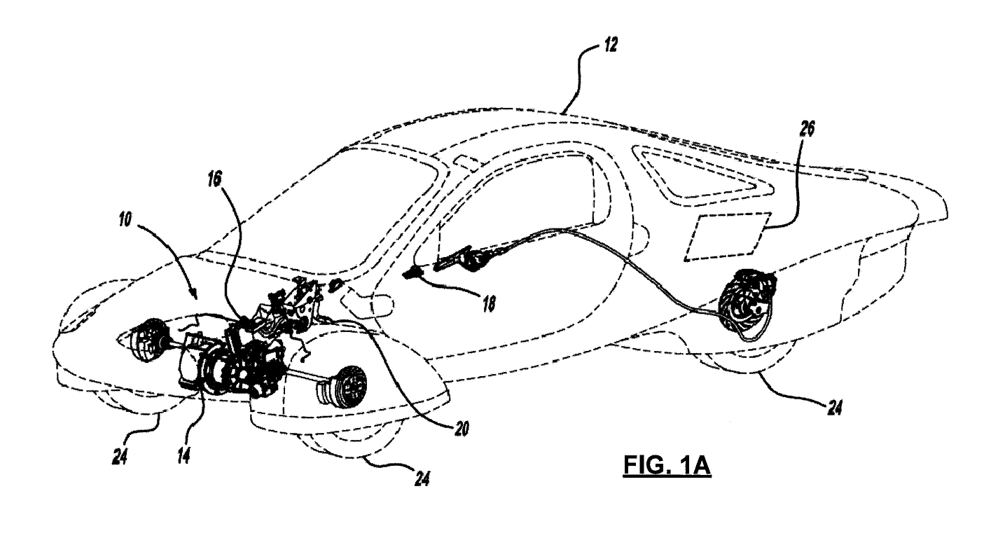

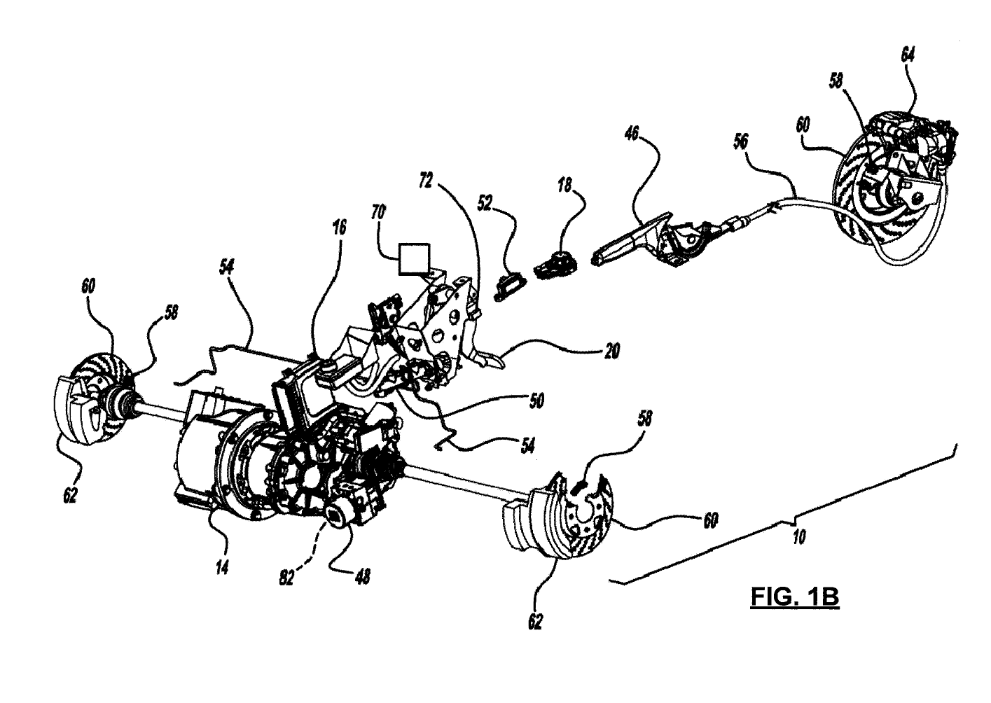

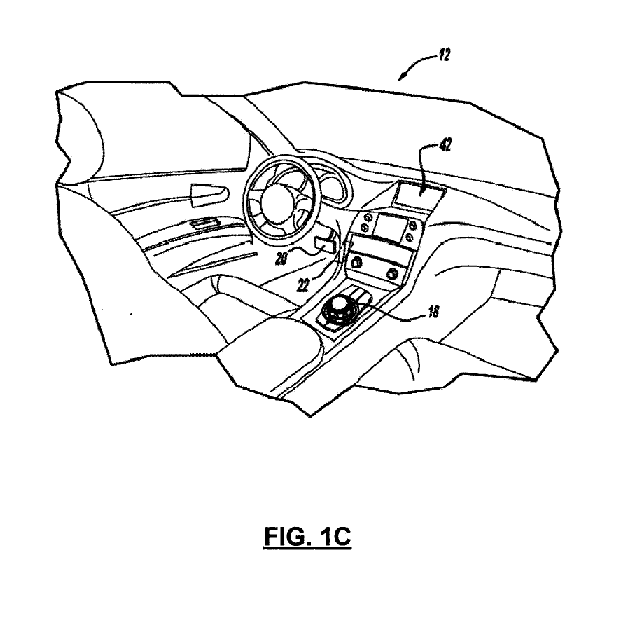

The preferred embodiment of a regenerative braking system 10 for an electric drive vehicle 12 is illustrated and described with respect to FIGS. 1 through 12. System 10, as described herein, allows kinetic energy from vehicle 12 to be re-absorbed by an energy storage system, achieves a consistent braking system meeting Federal Motor Vehicle Safety Standards (FMVSS), and meets specific performance objectives (e.g., stopping distance, pedal force application, relationships between brake pedal force, displacement, and vehicle deceleration, etc.), while smoothly blending the transition between electrical regenerative braking and friction braking.

With reference now to FIGS. 1 through 4, vehicle 12 includes regenerative braking system 10, an electric motor 14 with an inverter 15, a vehicle control unit or module (VCU) 16, an electronic shift controller 18, a brake pedal 20, and an accelerator pedal 22. During vehicle acceleration, electric motor 14 converts electrical energy into mechanical energy for providing motion to wheels 24 of vehicle 12. For example, electric motor 14 may include a rotor embedded with a permanent magnet and a stator wound around a stator coil (not shown). Upon a command from VCU 16, a current may be applied to electric motor 14 causing the motor to begin spinning and, thereby, causing rotation of wheels 24. Electric motor 14 may receive power from an energy storage system 26 (e.g., main battery pack, storage capacitors, etc.). As can be seen, electric motor 14 is a drive motor for providing motion to wheels 24 of vehicle 12 and should not be confused with other internal vehicle motors (e.g., window lift motor).

Electric motor 14 may also be used as a generator assisting with vehicle deceleration through operation of inverter 15. Inverter 15 is an electrical device that communicates with electric motor 14 to convert direct current to alternating current bi-directionally through appropriate electrical elements and/or control circuits. In this way, electric motor 14 may use kinetic energy of vehicle 12 to create a store of electrical energy at energy storage system 26. For example, operating electric motor 14 with inverter 15 generates an electromotive force between ends of the stator coil, which is then transferred to energy storage system 26. Energy storage system 26 can later be tapped for utilization in the drivetrain of vehicle 12 (e.g., during acceleration) or can be used to power vehicle systems, such as climate controls and other electrical componentry. This reverse operation of electric motor 14 is initiated by mapping brake pedal 20 and/or accelerator pedal 22, either statically or dynamically, to respond to a request for deceleration in a process known as regenerative braking.

It should be understood that this regenerative energy can be sent to a main, high-voltage electrical bus where it may be distributed amongst energy storage system 26, vehicle devices, and various dissipative load dump elements. In order to maintain a consistent pedal and driving feel, however, this energy should be routed appropriately between energy storage system 26, a load dump, and friction braking, as will be described in detail below.

With continued reference to FIGS. 1 through 3, VCU 16 is a standard control module, and as such, will not be described in detail herein. In the preferred construction, however, VCU 16 includes ROM and RAM memory for storing various instructions for operation. The term “memory” is used to include, but not be limited to, non-transient fixed or removable memory, hard drives, compact discs, memory sticks, magnetic tapes, and the like. Programmed software instructions are stored in the memory and run on a microprocessor or other central processing unit in, or associated with, VCU 16. Input devices, such as a keyboard and/or display screen, may be employed for manually setting target values and/or to visually observe automatically measured resultant values.

Electronic shift controller 18 includes an adjustable knob or joystick 28, a pair of window lift buttons 30, 32 for raising and lowering windows of vehicle 12, a door lock/unlock button 34, a central button 36 for maintaining adjustable knob 28 in a particular mode or shift position, and a pair of buttons 38, 40. The buttons 38, 40 can be configured to activate other features of vehicle 12, such as, but not limited to, a traction control system, a valet mode, a trunk release, a sunroof, and a rear window defroster. As shown, electronic shift controller 18 is preferably located within a center console area 42 of vehicle 12, but may be located anywhere in vehicle 12 that is easily accessible by the vehicle operator. Additionally, the regenerative adjustment feature of electronic shift controller 18 may be separated into a different user interface device, such as, buttons on the steering wheel or a touch screen in center console area 42.

Adjustable knob 28 is configured to move in the x-direction and y-direction for switching between shift modes (e.g., drive, neutral, reverse, park). Adjustable knob 28 is also configured to provide multiple forward drive modes. In this regard, vehicle operator can sequentially move adjustable knob 28 from centered z-direction to the positive y-direction and back to sequence between multiple driving modes. Accordingly, electronic shift controller 18 communicates signals to VCU 16 corresponding to a first or economy drive mode, a second or normal drive mode, and a third or high performance drive mode. Additional details of electronic shift controller 18 may be found in commonly owned U.S. patent application Ser. No. 12/957,771 (Attorney Docket No. 33321-000009), entitled “Shift Controller Apparatus”, invented by Curtis et al. and filed concurrently herewith, which is expressly incorporated herein by reference.

Rotation of adjustable knob 28 in the direction of arrow 44 provides manual adjustment to the distribution between electrical braking and friction braking (i.e., for varying intensity of regenerative braking). For example, the vehicle operator may choose to use regenerative braking system 10 immediately upon easing off accelerator pedal 22. Additionally, the vehicle operator may adjust regenerative braking system 10 to take vehicle 12 promptly down to 0 MPH (KPH) or to allow vehicle 12 to coast slightly. In order to provide fine-tuned manual adjustment to regenerative braking system 10, electronic shift controller 18 is shown as a rheostat having a manually adjustable resistance. It should be understood, however, that other possible switch designs are contemplated. For example, electronic shift controller 18 may also be an optical encoder, a rotary position sensor (e.g., wheel style), a linear position sensor, a momentary switches (e.g., one switch for increased regenerative braking and another for decreased), an application of a displacement to an accelerator member, a joystick initiation, a variable switch, a throttle switch, a twist throttle, a throttle lever, or any other device for manually adjusting regenerative braking system 10.

Adjustable knob 28 includes a plurality of detent mechanisms (not shown) corresponding to discrete levels of regenerative braking from accelerator pedal 22 or any other sensor separate from brake pedal 20. For example, adjustable knob 28 may include 16 detent locations for adjusting the intensity, while still obtaining the maximum amount of energy possible from regenerative braking system 10. Adjustable knob 28 may be tuned to provide the vehicle occupant with the intended driving experience and to meet vehicle targets. As should be understood, adjustable knob 28 may be tuned to provide any value between 0% to 100% of the potential electrical braking. In this way, the vehicle operator may adjust vehicle 12 to provide an appropriate balance between comfort and vehicle efficiency. It should be understood that with a higher level of electrical braking, vehicle 12 becomes more energy-efficient. User-adjustable regenerative braking is at accelerator pedal 22, but boost from brake pedal 20 operates under a fixed algorithm (i.e., not adjustable by the vehicle operator). Notably, however, these values are interconnected, as will be described in detail below.

Electronic shift controller 18 is a low-speed (e.g., operating at 100 kbps) controller area network-based system (CAN) requiring only four circuits (e.g., battery feed circuit, ground, and two CAN functions). Accordingly, less wiring, weight, and cost are required for operation. Furthermore, the CAN-based system provides the ability to override current shift mode into park mode if vehicle 12 is in drive mode after the vehicle occupant exits vehicle 12. Electronic shift controller 18 also includes built-in diagnostic settings, which are utilized to prevent unintentional operation due to an inadvertent actuation of electronic shift controller 18. While the CAN-based system is described as operating at low speeds and having only four circuits, other speeds and numbers of circuits are contemplated. Furthermore, network-based CAN communication should be understood to be any communication interface.

While vehicle 12 is in operation, electronic shift controller 18 may be kept in a live mode through CAN management. For example, a single message may be sent to electronic shift controller 18 in a cyclic interval. Electronic shift controller 18 may also have a sleep mode corresponding to a vehicle lights off condition. After each startup, electronic shift controller 18 may be reset to broadcast an appropriate signal.

Regenerative braking system 10 is capable of combined electrical braking and friction braking. Accordingly, regenerative braking system 10 includes brake pedal 20, accelerator pedal 22, a parking brake handle 46, an optional brake hydraulic electronic control unit (H ECU) 48, a non-boosted master cylinder 50, a brake sensor cluster for vehicle accelerations 52, brake lines 54, brake cable 56, and wheel speed sensors 58, but also includes rotors 60, front calipers 62, and at least one combined rear caliper 64. The vehicle operator may depress brake pedal 20 when it is desired to reduce vehicle speed. A gap between calipers 62, 64 and rotors 60 exists to minimize brake drag during vehicle movement when brake pedal 20 is not depressed. To maintain expected brake feel, a specified amount of electrical braking may occur before friction braking begins (“jump-in” regenerative braking). This “jump-in” or stepped regenerative braking may be initiated via an indication of brake pedal apply (i.e., initiated through a signal from a stop light switch 72 mounted on brake pedal 20).

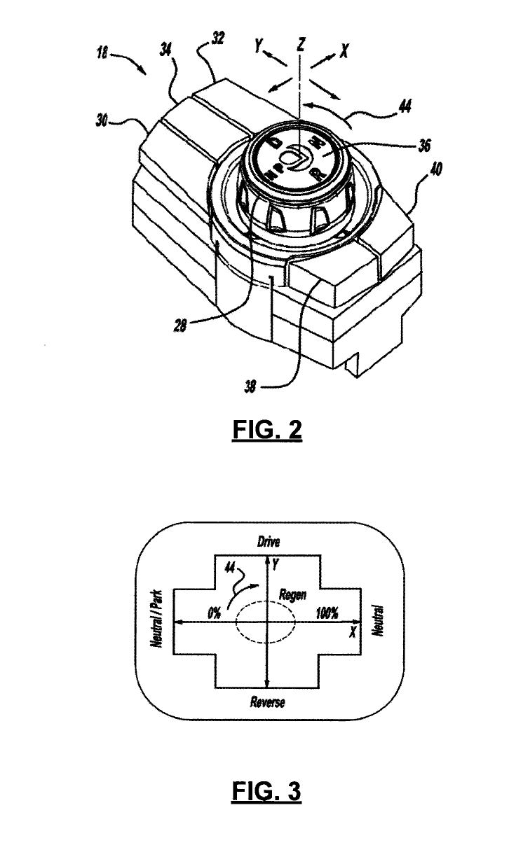

With reference to FIG. 4, a diagram showing a high level CAN interface between electronic shift controller 18 and electric motor 14 is shown. As previously described, electronic shift controller 18 is located within center console area 42 of vehicle 12. As such, actuation of electronic shift controller 18 by vehicle operator is directly communicated to an interior control module (ICM) 66 over a CAN bus (e.g., at 100 Kbps). ICM 66 sends a signal to a gateway module 100 over a second CAN bus (e.g., at 500 Kbps) indicative of the actuation of electronic shift controller 18. Gateway module 100 translates the signal into a form acceptable by VCU 16 and sends it through a third CAN bus (e.g., at 500 Kbps) to VCU 16. A battery control module (BCM) 68, likewise, receives the third CAN bus signal and begins communication with VCU 16. As will be described, brake and accelerator pedals 20, 22 are also in direct communication with VCU 16 for providing signals indicative of vehicle operation. VCU 16 then provides a signal to inverter 15 to reverse operation of electric motor 14 for enabling its use as a generator for regenerative braking system 10, as will be described in detail below. While communication between electronic shift controller 18 and VCU 16 is described as being performed over a plurality of devices, it should be understood that the regenerative adjustment interface may communicate through any known manner.

Communication between electronic shift controller 18 and ICM 66 allows for visual feedback regarding regeneration level to the vehicle occupant through the vehicle's cluster display. Electronic shift controller 18, however, may provide feedback to the vehicle occupant in various other ways. For example, vehicle 12 may provide audio feedback (e.g., an increased radio volume or tone, a voice indicator stating current regeneration level) and/or haptic feedback (e.g., varied resistance to rotation of adjustable knob 28, varied detent length). With either audio feedback or haptic feedback, the vehicle occupant would be alerted to regeneration level without having to view the vehicle's cluster display.

During braking, a brake pedal position sensor 70 or stop light switch 72 operably relays a signal indicative of displacement of brake pedal 20 to VCU 16. VCU 16 may request an initial amount of regenerative braking based on this signal (i.e., “jump-in” regenerative braking). Additionally, the displacement of brake pedal 20 corresponds to a force applied to brake pedal 20 and an internal brake system hydraulic pressure. VCU 16 may use this hydraulic pressure, along with other inputs (e.g., vehicle speed via wheel speed sensors 58), to develop a powertrain regenerative braking request from brake pedal 20. The request derived from brake pedal inputs is obtained from a fixed set of logic that is not adjustable by the vehicle operator. VCU 16 may receive the hydraulic pressure and other inputs via the CAN. For example, pressure and vehicle speed may be fed through HECU 48, which then broadcasts the information on the CAN. By having powertrain brake regeneration from brake pedal 20 via a fixed set of logic that is not user-adjustable, a vacuum boosted brake system may be eliminated while still meeting certain brake-related requirements under FMVSS. On a typical electric vehicle without a source of vacuum from the engine, an electric vacuum pump may be required for boost. Powertrain brake regeneration from the brake pedal thus eliminates this need. Accordingly, regenerative brake system 10 can be used as a brake boost for providing optimized brake system feel and performance without the need for a vacuum booster or other boosting means.

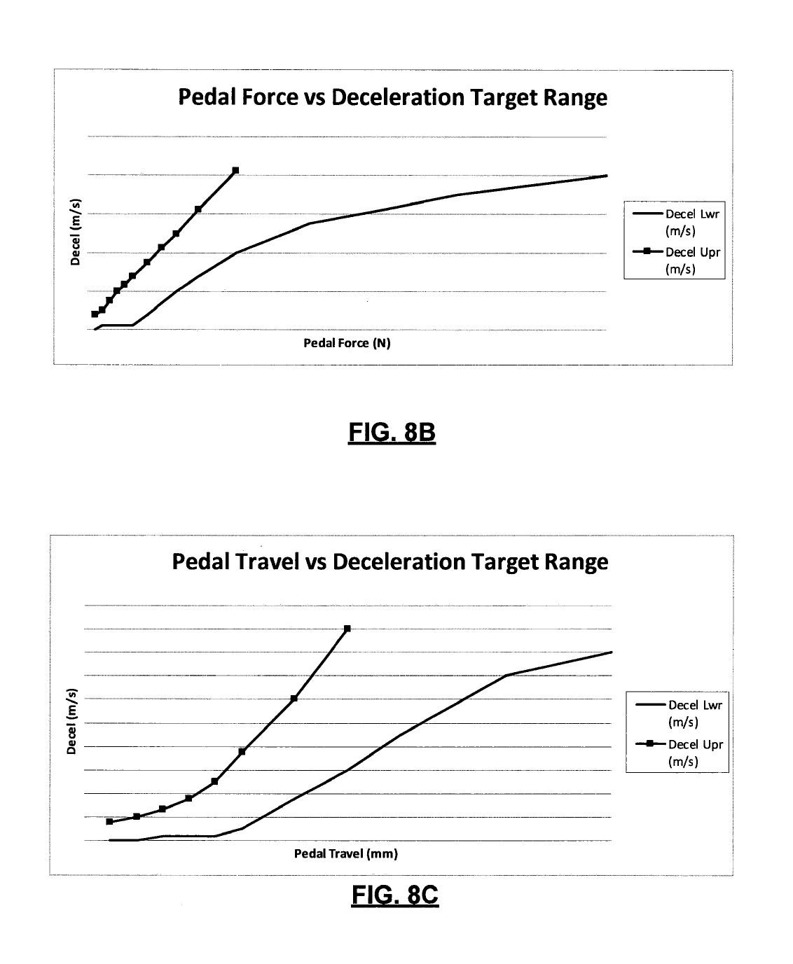

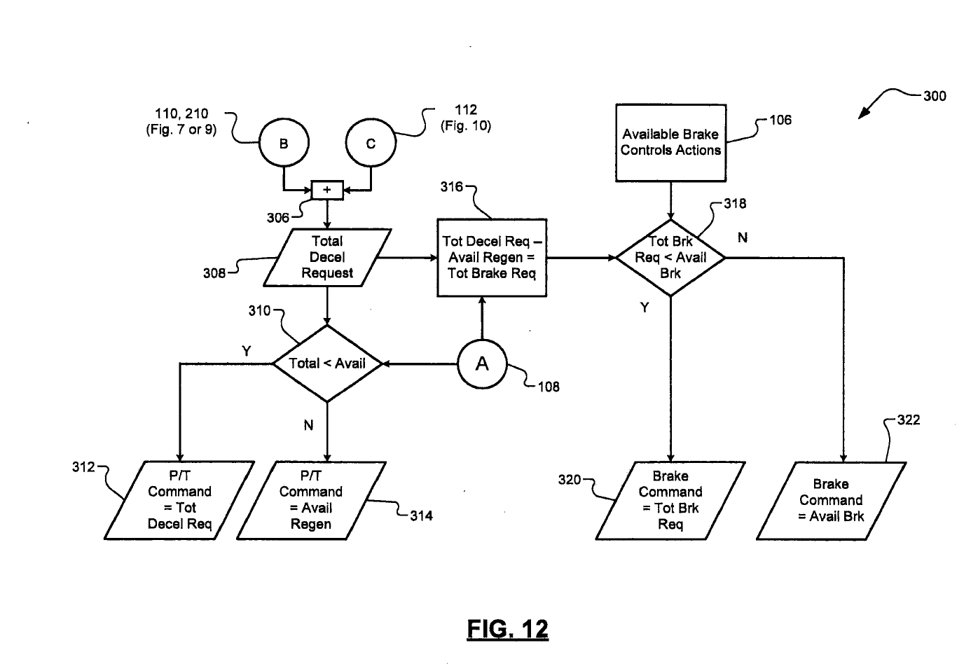

Regenerative braking may also be implemented in conjunction with a brake control unit or an antilock brake system/electronic stability control (ABS/ESC) system. VCU 16 calculates torque available to generate electricity to be fed back to energy storage system 26. In this way, VCU 16 monitors an inflow of electricity to energy storage system 26 to prevent an overload. VCU 16 is also supported by HECU 48, along with the friction braking system including master cylinder 50, rotors 60, and front and rear calipers 62, 64. VCU 16 and its software determine whether electric motor 14 is currently capable of handling the torque necessary to stop vehicle 12. If electric motor 14 and energy storage system 26 are not capable of providing the necessary torque, VCU 16 obtains further braking assistance from the friction braking system via HECU 48. For example, as shown in the alternative configurations of FIGS. 9 and 12, HECU 48 may cause master cylinder 50 to transmit pressure and brake fluid to brake lines 54 for actuating front calipers 62 to frictionally interface with friction rotors 60, thereby providing mechanical stopping torque for wheels 24.

Regenerative braking system 10 of the present invention operates under certain assumptions. For example, it is assumed that there is a maximum braking torque that is limited by friction between the tires and the road surface, but this limit changes dynamically based on operating conditions. It is also assumed that a maximum amount of power can be recovered by electric motor 14 at any given time, which may be caused by the inability to conduct additional current (e.g., hardware saturated due to temperature level, switching frequency, etc.). Additionally, only a certain amount of energy may be absorbed by energy storage system 26 at any given time due to present storage level (e.g., main battery pack stores full) and requested power level (e.g., current limits, temperature, voltage). It should also be noted that existing on-board high voltage components may also dynamically dissipate power (e.g., the HVAC system, DC to DC converter, etc.). Finally, any energy that is not absorbed by energy storage system 26 must be dissipated either in an electrical element or between rotors 60 and calipers 62, 64.

Regenerative braking system 10 may be initiated through various means. For example, regenerative braking system 10 may be initiated by stop light switch 72 connected to brake pedal 20. As the vehicle operator displaces brake pedal 20, brake pedal position sensor 70 sends a signal to VCU 16 indicative of brake pedal displacement. Pedal force is inferred from a brake system pressure sensor (not shown) that may be located in HECU 48. Brake pedal displacement activates stop light switch 72, which is an input to a decision/logic module 102 described in more detail below. In one configuration, this input can be used to initiate the “jump-in” regenerative braking while brake pads (not shown) on brake calipers 62, 64 are being brought into contact with rotors 60 through the hydraulic system before significant brake line pressure is developed. This allows for a targeted pedal feel and a minimized amount of brake drag from pad-to-rotor contact when brake pedal 20 is not depressed.

Alternately, regenerative deceleration due to regenerative braking system 10 is initiated by other available sensors 78 (for example, but not limited to, one or more rotary potentiometers on accelerator pedal 22 shown in FIG. 4) for dialing in an appropriate amount of regenerative deceleration. In this case, a signal may be relayed through to VCU 16 indicative of a regenerative condition. VCU 16, in turn, requests regenerative deceleration from regenerative braking system 10.

In a third embodiment, regenerative braking system 10 is initiated by measurement of pressure in brake lines 54. Accordingly, a brake pressure sensor 82 sends a signal to relay information indicative of a regenerative condition and actuation of friction brakes to VCU 16. VCU 16, in turn, activates the regenerative braking system 10. Brake pressure sensor 82 may be located internal or external to HECU 48 for communication directly with HECU 48. A signal indicative of hydraulic pressure may then be broadcast over the CAN. Alternatively, brake pressure sensor 82 may communicate with VCU 16, omitting communication through HECU 48. The hydraulic may then be used to infer brake pedal user apply force.

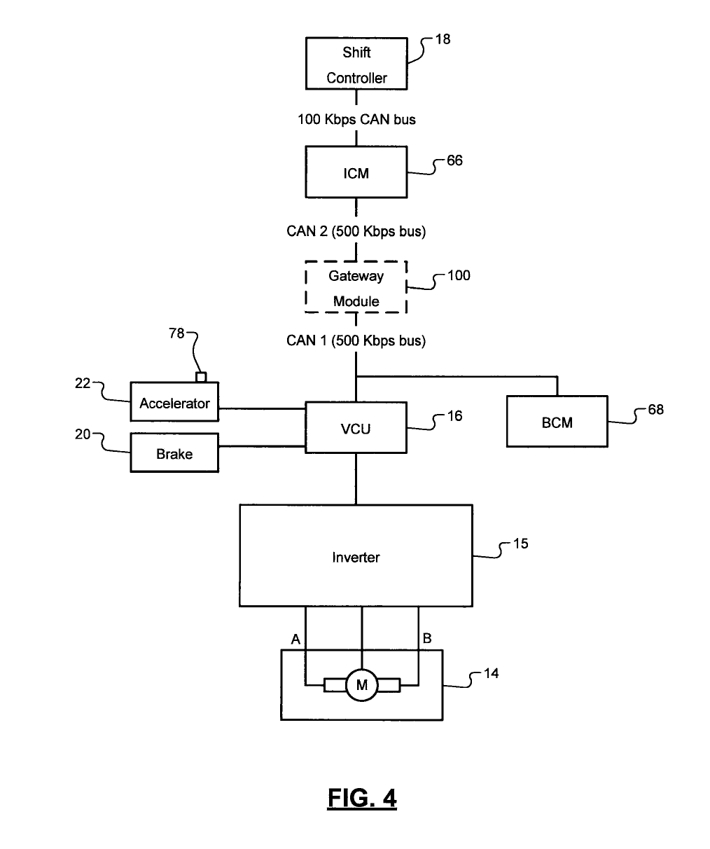

With reference now to FIG. 5, gateway module 100 provides a process for operation of regenerative braking system 10 including providing various inputs to decision/logic module 102. Decision/logic module 102 may be integrated within HECU 48, but is preferably integrated within VCU 16. As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories. The terms code and software are used interchangeably herein.

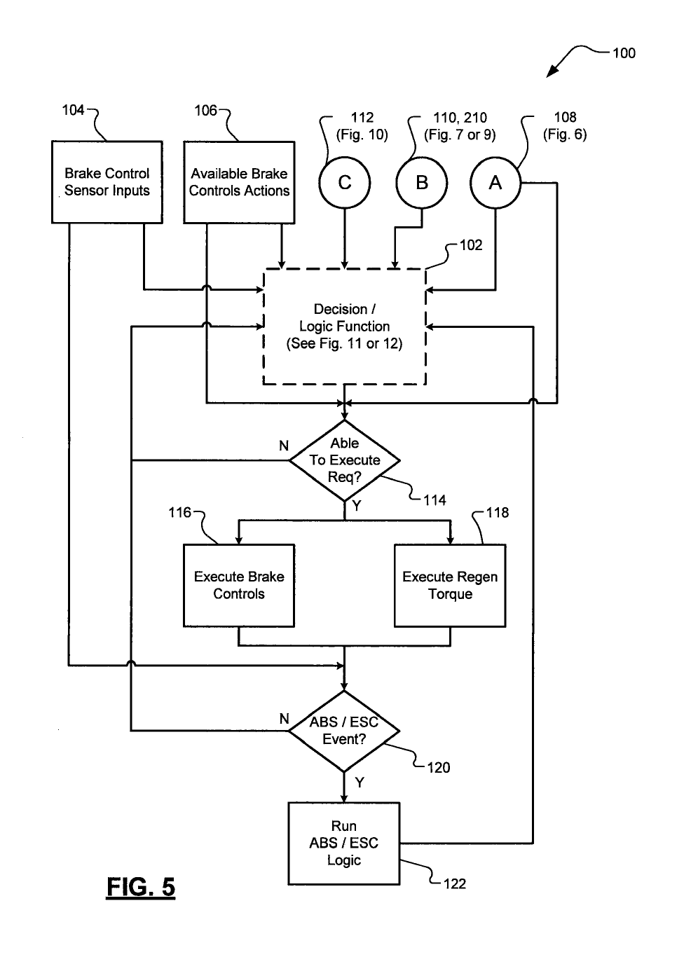

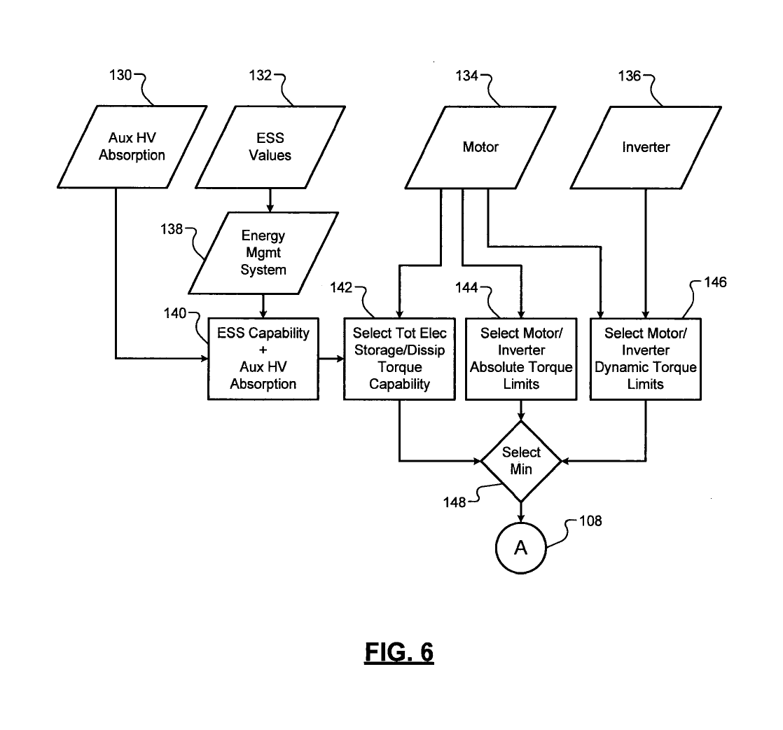

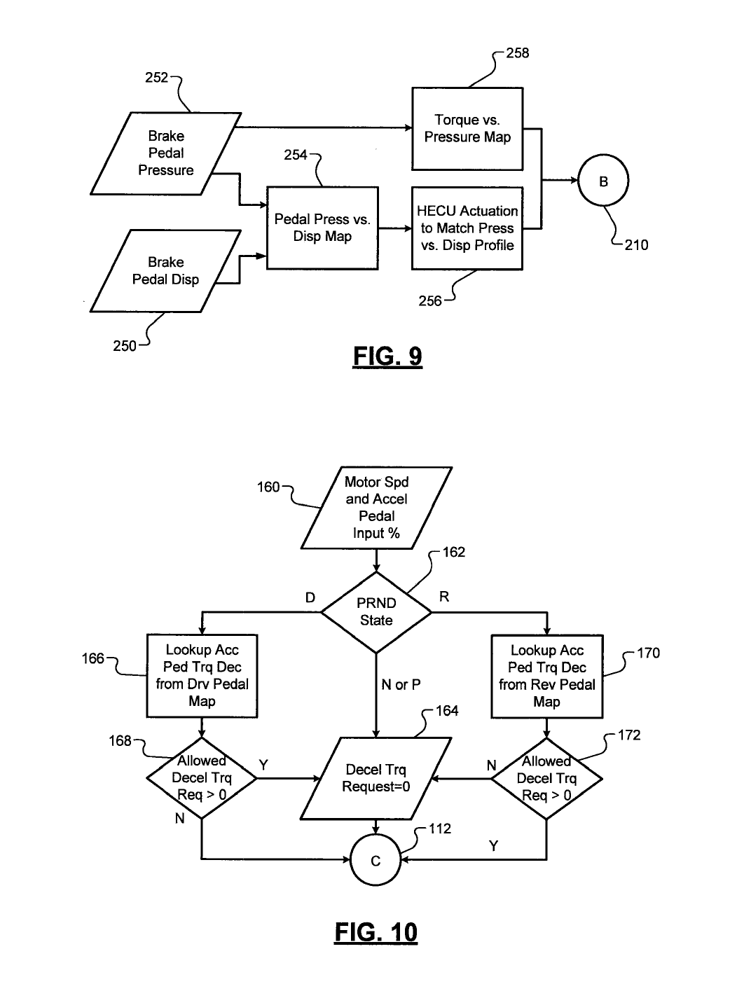

Decision/logic module and software 102 receive inputs from brake control sensor inputs 104, available brake controls actions 106, available deceleration torque at electric motor module 108 (see FIG. 6); brake pedal deceleration request logic 110 (see FIG. 7); and accelerator pedal deceleration request logic 112 (see FIG. 10). Decision/logic module and software 102 compile the inputs and utilize lookup charts tuned during vehicle development to generate various requests for operation of regenerative braking system 10. After compilation of the various inputs, decision/logic module and software 102 set the requests for desired action for powertrain regeneration and brake controls action (if any). The requests are evaluated to determine if execution is possible in step 114. If not possible, this information is resent to decision/logic module 102. If execution is possible, the requests are then commanded in steps 116, 118. After commanding brake controls and regenerative torque in steps 116, 118, the system 10 is evaluated to determine if an ABS/ESC event is occurring in step 120. If an ABS/ESC event is occurring, logic pertaining to this event is executed in step 122. After execution, and also if no ABS/ESC event is determined to be occurring, this information is relayed to decision/logic module 102.

The various inputs will now be described in detail. Brake control sensor inputs 104 include but are not limited to: brake line pressure, wheel speed (vehicle speed), vehicle accelerations (long/lat/yaw/pitch/roll), brake pedal displacement (stop light switch 72 or complete position information), and steering wheel angle. These values may be provided from brake pedal 20 (i.e., brake pedal displacement), HECU 48 (i.e., brake system pressure), brake sensor cluster 52 (i.e., vehicle accelerations), and wheel speed sensors 58. For example, brake pedal 20 provides displacement information through brake pedal position sensor 70 or an initial displacement indication through stop light switch 72. Speed sensors 58, such as an optical encoder, hall effect sensor or the like, sense revolutions per minute of the vehicle wheels 24 in order to detect and send a signal to HECU 48 indicative of the speed of vehicle 12. HECU 48 also provides system hydraulic pressure information resulting from the brake pedal inputs. Brake sensor cluster 52 provides various positional inputs, such as, longitudinal values, latitudinal values, yaw values, pitch values, and roll values. Wheel speed sensors 58 provide information related to current speed of vehicle 12. Additionally, brake control sensor inputs 104 also provide values related to the steering wheel angle.

Available brake controls actions 106 dictate the possible brake controls output requests from decision/logic module and software 102. Notably, available brake controls actions 106 is evaluated again in step 114 after decision/logic module and software 102 has completed the requests in order to evaluate if it is possible to execute the requests.

With reference now to FIG. 6, available deceleration torque at electric motor module and software 108 is obtained by evaluating various input values, such as, auxiliary high voltage absorption (including dissipation) 130, energy storage system (ESS) values 132, electric motor values 134, and inverter values 136. In operation, ESS values 132 such as current, voltage, battery temperature, state of charge, and absolute energy usage are limited by an energy management system 138. The limited value from energy management system 138 is combined with a power limit obtained from auxiliary high voltage absorption 130 in step 140. This combined power input value is used to select total electrical storage/dissipation torque capability in step 142. Total electrical storage/dissipation torque capability may be obtained from a lookup table based on motor torque versus power input and motor speed. It should be understood that values in the look up tables can be characterized in other ways, such as via characteristic equation sets, thereby, bypassing the lookup table.

Motor speed is also used to obtain motor/inverter absolute torque limits in step 144 and motor/inverter dynamic torque limits 146. Motor/inverter absolute torque limits 144 are obtained from another predetermined and stored lookup chart comparing motor torque against motor speed. Motor/inverter dynamic torque limits 146 are calculated directly from values obtained from electric motor 14 and inverter 15, such as motor speed, current in motor, motor temperature, inverter temperature, current in inverter, and frequency of inverter. Motor/inverter absolute torque limits 144, motor/inverter dynamic torque limits 146, and total electrical storage/dissipation torque capability 142 are then compared in step 148 to obtain a minimum value for available deceleration torque at electric motor 108 for input into gateway module 100.

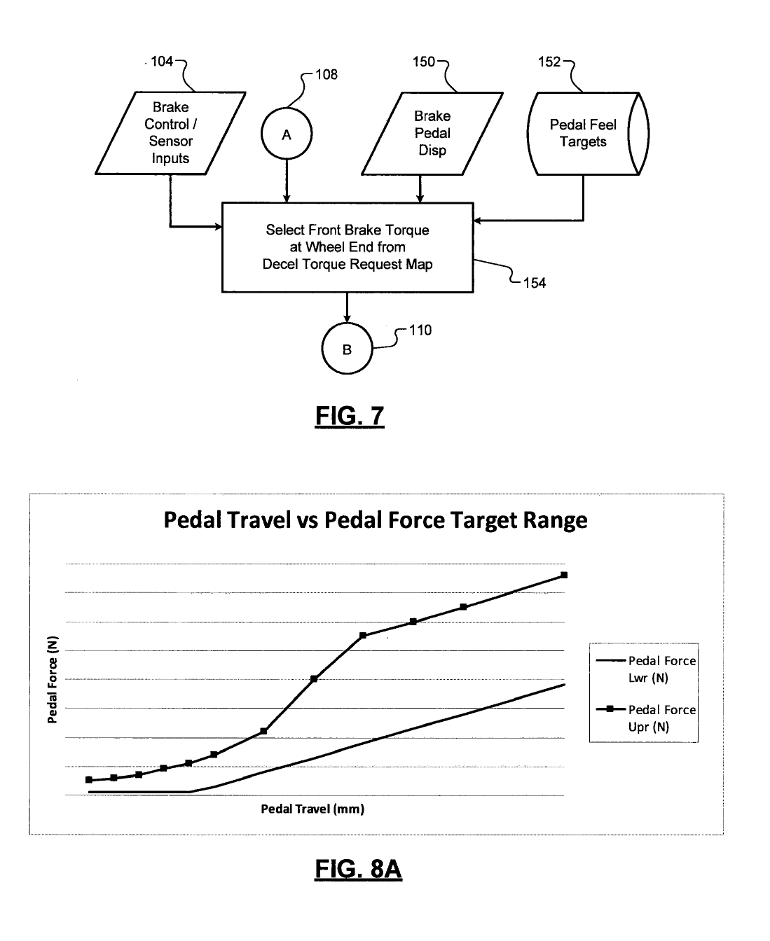

Referring now to FIGS. 7, 8a, 8b, and 8c, brake pedal deceleration request logic 110 calculates by evaluating various values, such as, brake control sensor inputs 104 (as previously described above with respect to FIG. 5), available deceleration torque at electric motor module 108 (as previously described above with respect to FIG. 6), brake pedal displacement information 150, and brake pedal feel targets 152. Brake pedal displacement information 150 is obtained and used directly from brake pedal position sensor 70. Alternatively, only the initial indication of brake pedal displacement from stop light switch 72 on brake pedal 20 may be used. Brake pedal feel targets 152 are input and used for creating the deceleration torque request mapping in 154. The relationship between these values is shown in FIG. 8a (pedal travel versus pedal force target range), FIG. 8b (pedal force versus deceleration target range), and FIG. 8c (pedal travel versus deceleration target range). These targets can be used to determine the need for and amount of a brake boost. Ultimately, the input values 104, 108, 150, 152 are used to determine a desired regenerative front brake torque at the wheel end based on parameters including, but not limited to, vehicle speed, brake line pressure, and available powertrain deceleration torque versus speed via a deceleration torque request map in step 154 to determine an appropriate brake pedal deceleration request 110 for input into gateway module 100.

With reference now to FIG. 9, an optional configuration may also be utilized for calculating brake pedal deceleration request module 210. Brake pedal displacement values 250 and brake pedal pressure values 252 are input to a stored pedal pressure versus displacement map 254 for obtaining a pressure versus displacement profile. This profile is then used to request action from HECU 48 in step 256. HECU 48 requests, along with values from a torque versus pressure map obtained from brake pedal displacement values 250, result in an appropriate input to finalize the requested brake controls action and powertrain regenerative torque request in gateway module 100.

Referring now to FIG. 10, accelerator pedal deceleration request module 112 is determined by analyzing both electric motor 14 speed and accelerator pedal 22 input percentage in step 160. These inputs are evaluated with respect to vehicle shift state (e.g., park, reverse, neutral, drive) in step 162. If vehicle 12 is determined to be in a park or neutral state, deceleration torque request is set to zero (step 164) and sent for input into gateway module 100. If vehicle 12 is determined to be in a drive state, the inputs are sent to a stored drive pedal map where an accelerator pedal torque deceleration request is obtained (step 166). If the allowed deceleration torque request is determined to be greater than zero (step 168), than the value is once again set to zero (step 164) before being input into gateway module 100. A negative value for deceleration torque request is sent, as is, directly into gateway module 100. Conversely, if vehicle 12 is determined to be in a reverse state, the inputs are sent to a reverse pedal map where an accelerator pedal torque deceleration request is obtained (step 170). If the allowed deceleration torque request is determined to be greater than zero (step 172), than the value for deceleration torque request is sent directly into gateway module 100. If, however, the deceleration torque request is less than zero, it is once again set to zero (step 164) before being input into gateway module 100.

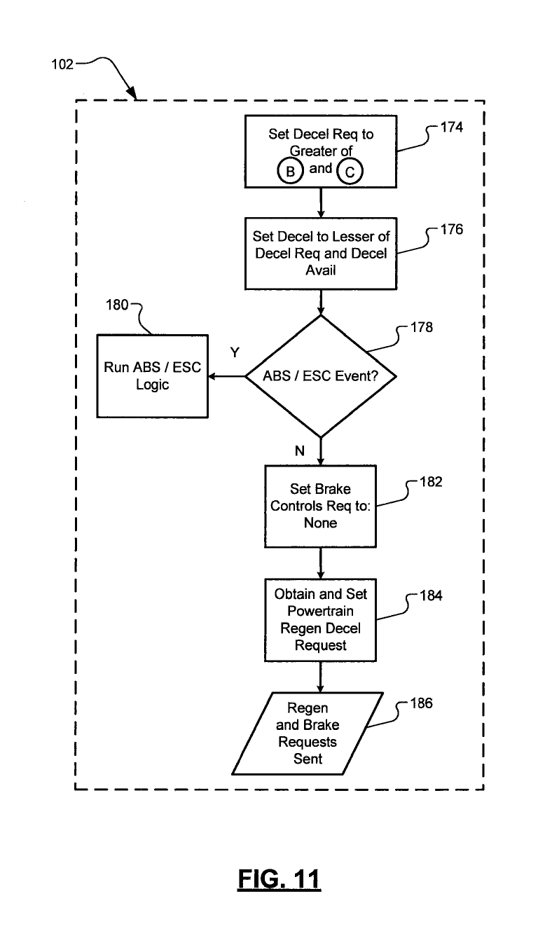

With reference now to FIG. 11, decision/logic module and software 102 will now be described in detail. After all inputs are received, a value for a deceleration request is set to the greater of the values of brake pedal deceleration request 110 and accelerator pedal deceleration request 112 in step 174. Next, the deceleration value is set to the lesser of deceleration requested and deceleration available (step 176). The system 10 is evaluated to determine if an ABS/ESC event is occurring in step 178. If an ABS/ESC event is occurring, logic pertaining to this event is executed (step 180). If an ABS/ESC event is not occurring, brake controls request is set to none (step 182) and a powertrain regenerative deceleration request is set (step 184). These regenerative and brake requests are then sent to VCU 16 and its software (step 186) for further processing and completion of decision/logic module and software 102.

Referring now to FIG. 12, an optional process 300 may also be utilized for operation of regenerative braking system 10. In particular, various values from brake pedal deceleration request module 110 (see FIG. 7), accelerator pedal deceleration request module 112 (see FIG. 10), available brake controls actions 106, and available deceleration torque at electric motor module 108 may be used to generate both powertrain and brake command requests for operation of regenerative braking system 10. Brake pedal deceleration request logic 110, along with the accelerator pedal deceleration request logic 112, are summed (step 306) to obtain a total deceleration request (step 308). Available regeneration from available deceleration torque at electric motor module 108 is compared to total deceleration request 308 in step 310. If total deceleration request 308 is less than available regeneration, a powertrain command is set equal to the value of total deceleration request 308 (step 312). If, however, total deceleration request 308 is greater than available regeneration, then the powertrain command is set equal to the value of available regeneration in step 314.

Available regeneration may also be subtracted from total deceleration request 308 to obtain a total brake request in step 316. This total brake request 316 is compared to available brake controls actions 106 in step 318. If total brake request 316 is less than available brake controls actions 106, a brake command is set equal to the value of total brake request 316. If, however, total brake request 316 is greater than available brake controls actions 106, then brake command is set equal to available value in step 322.

The foregoing description of the embodiments has been provided for purposes of illustration and description. It is not intended to be exhaustive or to limit the disclosure. For example, while a three-wheeled vehicle is shown (two driving front wheels with one central rear wheel), a vehicle having an alternate wheel or drive wheel arrangement can also be employed (e.g., 2-wheeled, at least 4 wheels, AWD, FWD, RWD). Furthermore, while described as an electric drive vehicle, it should be understood that system 10 may also be applicable to other vehicle arrangements, such as, a hybrid electric and/or internal combustion drive vehicle. Individual elements or features of a particular embodiment are generally not limited to that particular embodiment, but, where applicable, are interchangeable and can be used in a selected embodiment, even if not specifically shown or described. The same may also be varied in many ways. For example, while foot-operated brake and accelerator pedals are shown and described, it is also contemplated that the system of the present invention may be used with vehicles having hand-controlled braking and acceleration. Furthermore, alternate braking systems are also contemplated, such as, disc brakes, drum brakes, air-actuated brakes, etc. Such variations are not to be regarded as a departure from the disclosure, and all such modifications are intended to be included within the scope of the disclosure.

What is claimed is:

1. An automotive vehicle braking system comprising:
a hydraulic brake system; and
a regenerative brake system in communication with the hydraulic brake system, the regenerative brake system having a fixed system logic and a user-adjustable system logic, wherein the fixed system logic is driven by a displacement to a brake member.

2. The automotive vehicle braking system of claim 1, wherein the fixed system logic and the user-adjustable system logic execute at least one of a powertrain regenerative command and a brake control unit command.

3. The automotive vehicle braking system of claim 2, wherein the brake control unit command increases a brake line pressure of the hydraulic brake system when the powertrain regenerative command requires supplement.

4. The automotive vehicle braking system of claim 1, wherein the fixed system logic calculates a rate of regenerative deceleration as a function of a brake member force.

5. The automotive vehicle braking system of claim 4, wherein the calculation includes a comparison of a requested regenerative braking and an available regenerative braking.

6. The automotive vehicle braking system of claim 1, wherein the regenerative brake system calculates a rate of regenerative deceleration as a function of at least one of the brake member displacement, an acceleration member displacement, and a vehicle velocity.

7. The automotive vehicle braking system of claim 6, wherein the calculation includes a comparison of total braking requested and available tractive effort.

8. The automotive vehicle braking system of claim 1, wherein the fixed system logic is preset.

9. The automotive vehicle braking system of claim 1, wherein the user-adjustable system logic is driven by a displacement to an acceleration member.

10. The automotive vehicle braking system of claim 1, wherein the fixed system logic is configured to activate a fixed rate of regenerative deceleration as a function of a vehicle user input.

11. The automotive vehicle braking system of claim 1, wherein the fixed system logic is initiated by a stop light switch on the brake member.

12. The automotive vehicle braking system of claim 1, wherein the fixed system logic and the user-adjustable system logic are performed in a vehicle controller.

13. An automotive vehicle braking system comprising:
a regenerative brake system;
a hydraulic brake system in communication with the regenerative brake system; and
a brake control unit providing a signal to activate the hydraulic brake system when a requested regenerative braking is greater than an available regenerative braking.

14. The automotive vehicle braking system of claim 13, wherein the hydraulic brake system executes a hydraulic brake boost.

15. The automotive vehicle braking system of claim 13, wherein the brake control unit decreases a brake line pressure when the available regenerative deceleration is greater than or equal to a desired total vehicle deceleration.

16. The automotive vehicle braking system of claim 13, wherein the brake control unit overrides the regenerative brake system.

17. The automotive vehicle braking system of claim 13, wherein the regenerative brake system receives at least one command from the brake control unit.

18. The automotive vehicle braking system of claim 13, wherein the brake control unit increases a brake line pressure independently of a displacement to a brake member.

19. A method for management of an automotive vehicle braking system comprising:
receiving a vehicle shift state, a brake member displacement and force, and an accelerator member displacement;
comparing the brake member displacement and force to a deceleration torque request map;
setting a brake member deceleration request based on the deceleration torque request map;
setting an accelerator member deceleration request to zero when vehicle shift state is in a park or neutral mode;
comparing the accelerator member displacement to one of a drive map when vehicle shift state is in a drive mode and a reverse map when vehicle shift state is in a reverse mode;
setting the accelerator member deceleration request based on one of the drive map and the reverse map when vehicle shift state is in the drive or reverse mode;
determining a brake control request and a regeneration torque based on the brake and accelerator member deceleration requests in comparison with an available regenerative brake in a decision module; and
executing the brake control request and the regeneration torque.

20. The method of claim 19, further comprising:
executing an antilock brake/electronic stability control logic after an antilock brake/electronic stability control event indicator is received.

21. The automotive vehicle braking system of claim 19, further comprising:
selecting a final commanded deceleration torque with a vehicle controller.

22. A method for management of an automotive vehicle braking system comprising:
displacing a brake member during a deceleration condition;
communicating the deceleration condition from a sensor to a vehicle controller;
calculating an available deceleration from a powertrain regeneration; and
activating a fixed system logic when the deceleration condition and a fixed system logic request exceeds a user-adjustable request.

23. The method of claim 22, further comprising:
executing at least one of a powertrain regenerative command and a brake control unit command with the fixed system logic.

24. The method of claim 23, further comprising:
increasing a brake line pressure of a hydraulic brake system when the powertrain regenerative command requires supplement.

25. The method of claim 22, further comprising:
calculating a rate of regenerative deceleration as a function of at least one of the brake member displacement, an acceleration member displacement, and a vehicle velocity.

26. The method of claim 25, further comprising:
comparing a total braking requested and an available tractive effort.

27. The method of claim 22, further comprising:
presetting the fixed system logic.

28. The method of claim 22, further comprising:
driving a user-adjustable system logic by a displacement to an acceleration member.

29. The method of claim 22, further comprising:
activating a fixed rate of regenerative deceleration as a function of a vehicle user input with the fixed system logic.

30. The method of claim 22, further comprising:
initiating the fixed system logic with a stop light switch on the brake member.

31. The method of claim 22, further comprising:
performing the fixed system logic in a vehicle controller.
